(19) United States
(12) Patent Application Publication
(10) Pub. No.: US 2014/0095269 A1
(43) Pub. Date: Apr. 3, 2014

(54) AUTOMATED ASSESSMENT CENTER

(71) Applicants: William C. Byham, Pittsburgh (YS); Charles J. Cosentino, Bridgeville, PA (US); William Bradford Thomas, Bridgeville, PA (US); Douglas H. Reynolds, Bridgeville, PA (US); Paul R. Bernthal, Bridgeville, PA (US); Scott C. Erker, Bridgeville, PA (US)

(72) Inventors: William C. Byham, Pittsburgh (YS); Charles J. Cosentino, Bridgeville, PA (US); William Bradford Thomas, Bridgeville, PA (US); Douglas H. Reynolds, Bridgeville, PA (US); Paul R. Bernthal, Bridgeville, PA (US); Scott C. Erker, Bridgeville, PA (US)

(21) Appl. No.: 13/632,782

(22) Filed: Oct. 1, 2012

(51) Int. Cl. G06Q 10/06

(52) U.S. Cl. 705/7.39; 705/7.42

(57) ABSTRACT

Systems and methods for providing an automated assessment to a user may include authenticating, by a processor, the user for the automated assessment, providing, by the processor, a description of a job to the user, providing, by the processor, a plurality of tasks to the user, receiving, by the processor, a plurality of responses, wherein each response is elicited by at least one of the plurality of tasks, associating, by the processor, one or more first numerical scores with at least one response, providing, by the processor, at least a portion of a response to an evaluator for evaluation according to predetermined criteria, receiving, by the processor, one or more evaluations for at least a portion of one response, associating, by the processor, one or more second numerical scores that correspond to at least one evaluation and processing, by the processor, the one or more first numerical scores and the one or more second numerical scores to obtain an assessment rating.

### BACKGROUND

Organizations have sought for years to find a cost effective way to assess employee talent, competence and potential in a manner that provides organizations with the depth of insight necessary to make highly accurate, yet efficient hiring, promotion and development decisions. At the same time, both organizations and their employees need more structured processes for understanding employee strengths and weaknesses relative to a target job, and for using the information gathered to create and execute sound development plans.

Current assessment center methods generally assess a participant's proficiency at a competency level. These methods do not systematically measure key actions and the like which are the most critical behavioral components of competencies. As a result, traditional assessment center methods may contain inaccuracies, which may be due to, for example, a failure to comprehensively and systematically measure all the critical components of a competency. This may lead to improper hiring decisions, promotion decisions, guiding development and/or the like.

Furthermore, current assessment center methods are often quite costly and time consuming. In some cases, the assessment programs may require candidates and assessors to travel for extended periods of time, which take candidates and assessors away from critical job activities. Furthermore, assessors require considerable training, calibration and supervision to ensure accurate and reliable ratings. Current internet-based attempts to alleviate this issue have resulted in inadequate and ineffective assessments that generally require the selection of multiple choice or true-false questions and do not elicit or measure actual behavior directly.

### SUMMARY

In an embodiment, a method of providing an automated assessment to a user may include authenticating, by a processor, the user for the automated assessment, providing, by the processor, a description of a job to the user, providing, by the processor, a plurality of tasks to the user, receiving, by the processor, a plurality of responses, wherein each response is elicited by at least one of the plurality of tasks, associating, by the processor, one or more first numerical scores with at least one response, providing, by the processor, at least a portion of a response to an evaluator for evaluation according to predetermined criteria, receiving, by the processor, one or more evaluations for at least a portion of one response, associating, by the processor, one or more second numerical scores that correspond to at least one evaluation and processing, by the processor, the one or more first numerical scores and the one or more second numerical scores to obtain an assessment rating.

In an embodiment, a system for providing an automated assessment to a user may include a processor and a non-transitory, processor-readable storage medium in communication with the processor. The non-transitory processor-readable storage medium may contain one or more programming instructions that, when executed, cause the processor to receive a remote login request from the user, provide a description of a job to the user, provide a plurality of tasks to the user, receive a plurality of responses, associate one or more first numerical scores with at least one response, provide at least a portion of a response to an evaluator for evaluation according to predetermined criteria, receive one or more evaluations for at least a portion of one response, associate one or more second numerical scores that correspond to at least one evaluation and process the one or more first numerical scores and the one or more second numerical scores to obtain an assessment rating. Each response may be elicited by at least one of the plurality of tasks.

In an embodiment, a method of ensuring scoring accuracy of an assessor in an automated assessment may include receiving, by a processor, a plurality of assessment responses from a participant, assigning, by the processor, at least one of the assessment responses to the assessor for assessment, receiving, by the processor, at least one rating from the assessor and verifying, by the processor, that the ratings are accurate. The identity of the participant may be hidden from the assessor and each rating may correspond to one or more of the assessment responses.

### BRIEF DESCRIPTION OF THE DRAWINGS

FIG. 1 depicts a general schematic representation of an operating environment arranged in accordance with an embodiment.

FIG. 2 depicts a schematic representation of communications between an electronic device and one or more servers arranged in accordance with at least some embodiments described herein.

FIG. 3 depicts a block diagram of a plurality of modules used by one or more programming instructions according to an embodiment.

FIG. 4 depicts a flow diagram of a method of using an automated assessment center platform according to an embodiment.

FIG. 5 depicts a flow diagram of a method of evaluating and scoring according to an embodiment.

FIG. 6 depicts an example of a report according to an embodiment.

FIG. 7 depicts an example of a scoring form used by an assessor according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An “electronic device” refers to a device that includes a processor and a tangible, computer-readable memory. The memory may contain programming instructions that, when executed by the processor, cause the device to perform one or more operations according to the programming instructions. Examples of electronic devices include, but are not limited to, personal computers, gaming systems, televisions, and mobile devices.

A “mobile device” refers to an electronic device that is generally portable in size and nature. Accordingly, a user may transport a mobile device with relative ease. Examples of mobile devices include pagers, cellular phones, feature phones, smartphones, personal digital assistants (PDAs), cameras, tablet computers, phone-tablet hybrid devices (e.g., “phablets”), laptop computers, netbooks, ultrabooks, global positioning satellite (GPS) navigation devices, in-dash automotive components, media players, watches and the like.

A “computing device” is an electronic device, such as, for example, a computer or components thereof. The computing device can be maintained by entities such as financial institutions, corporations, governments, military, and/or the like. The computing device may generally contain a memory or other storage device for housing programming instructions, data or information regarding a plurality of applications, data or information regarding a plurality of users and/or the like. The programming instructions may be in the form of the operating environment, as described in greater detail herein, and/or contain one or more modules, such as software modules for carrying out tasks as described in greater detail herein. The data may optionally be contained on a database, which is stored in the memory or other storage device. The data may optionally be secured by any method now known or later developed for securing data. The computing device may further be in operable communication with one or more electronic devices. The communication between the computing device and each of the electronic devices may further be secured by any method now known or later developed for securing transmissions or other forms of communication.

A “server” is a computing device or components thereof that generally provides data storage capabilities for one or more computing devices. The server can be independently operable from other computing devices and may optionally be configured to store data in a database, a memory or other storage device. The server may optionally contain one or more programming instructions, such as programming instructions in the form of the operating environment, as described in greater detail herein, and/or one or more modules, such as software modules for carrying out tasks as described in greater detail herein. The server may have one or more security features to ensure the security of data stored within the memory or other storage device. Examples of security features may include, but are not limited to, encryption features, authentication features, password protection features, redundant data features and/or any other security features now known or later developed. The server may optionally be in operable communication with any of the electronic devices and/or computing devices described herein and may further be secured by any method now known or later developed for securing transmissions or other forms of communication.

An “automated assessment” is a system and/or a method contained within an application environment that includes programming instructions for providing an assessment tool for the evaluation of responses elicited by important and representative tasks in the target job and/or a job level for which the participant is being evaluated. The automated assessment's evaluation can be completed by sending one or more participants' responses to one or more assessors via a network in a remote location. In some embodiments, the automated assessment's evaluation can be completed by sending the one or more participants' responses asynchronously. The automated assessment may further be used to present tasks that elicit one or more responses from participants related to key actions or particular contexts. The system automatically associates ratings to one or more key actions with one or more competencies and computes key action, competency, overall ratings and narrative descriptions of observed behaviors for the assessment report. These key actions and competency levels may be used to assess how adept or prepared a participant is for a particular job, for tasks to be completed within a particular job and/or the like.

A “participant” is a user, such as the user of an electronic device, that completes an assessment as described herein. The participant may be an individual that uses the automated assessment, such as a prospective employee of an organization, a current employee, a person of interest and/or the like. The participant may generally agree to take an assessment with an organization and may connect to the one or more servers, as described herein, to schedule and complete the assessment.

A specific automated assessment center platform may always focus on a target position, such as, for example, a front line leader, a sales associate, an executive, a manufacturing associate and/or the like. Competencies and key actions may be established through a job analysis that includes interviewing and surveying job content experts in the target job across a variety of industries and cultures. The job analysis may be used to identify important and representative job activities that are then simulated in the assessment center. Once the assessment platform is configured to target job requirements, a sample of incumbents may complete the assessment process and their performance in it may be evaluated. Supervisors of the study participants may be asked to provide confidential ratings of study participants' performance in the target competencies as well as rate their performance in important outcomes such as productivity, engagement and retention. A statistical analysis may be completed to establish a relationship between the job performance and assessment center performance. The results may be used to weight and combine key action, competency and overall ratings. The results of the job analysis and validation study may also be used to shape the evaluation prompts and guidelines given to the assessors.

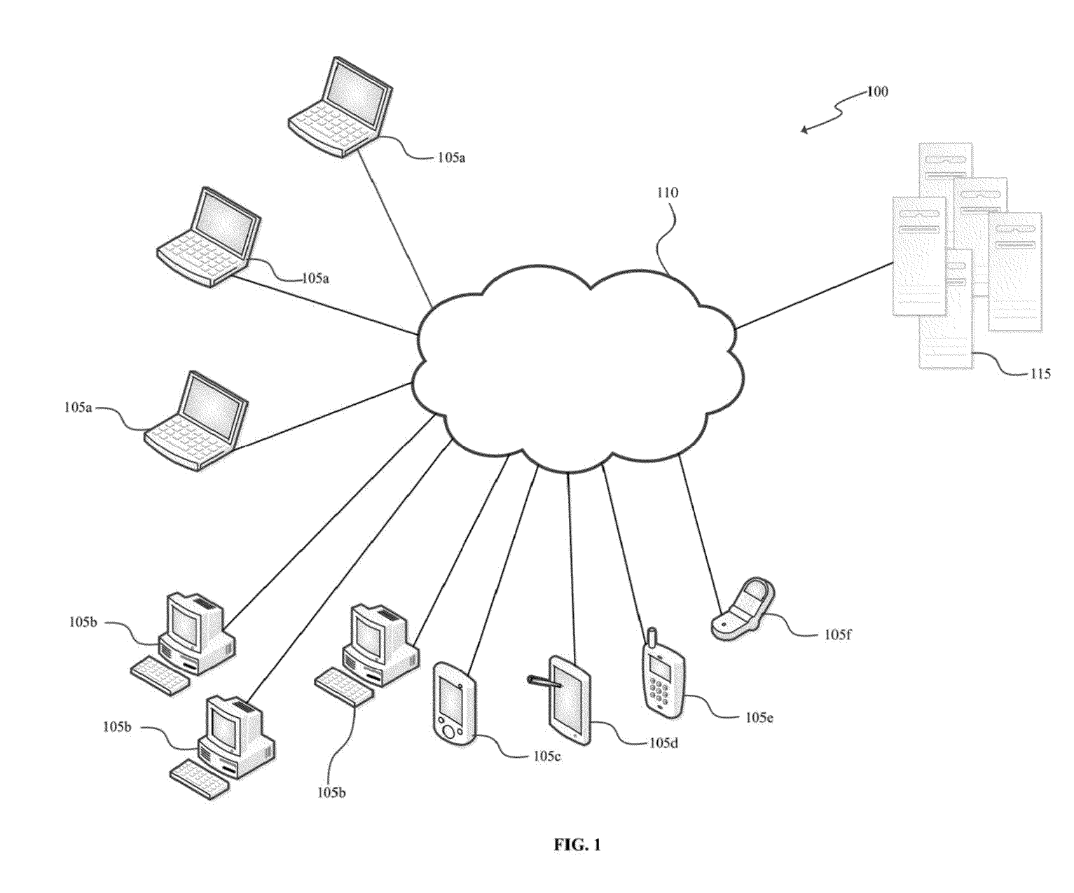

FIG. 1 depicts a general schematic representation of an operating environment 100, arranged in accordance with at least one embodiment described herein. The operating environment 100 may include one or more electronic devices 105 and one or more servers 115 configured to communicate with the one or more electronic devices via a communications network 110.

Each of the one or more servers 115 may be any server having a processing device and a storage medium. In embodiments where more than one server 115 is used, each server may operate independently of the other server, or may operate in an array-type configuration where the servers act as a single unit. The one or more servers 115 may optionally contain one or more databases, as described in greater detail herein. The one or more servers 115 may generally be used to provide the operating environment, obtain data from participants using the operating environment, transfer data between modules, process data in modules (as described in greater detail herein), create reports, provide reports and/or the like.

The one or more electronic devices 105, such as, for example, a laptop computer 105a, a desktop computer 105b, a PDA 105c, a tablet device 105d, a smartphone 105e and/or a feature phone 105f, may generally serve as a primary interface with a user and may further contain one or more applications that access the application environment, as described in greater detail herein. The one or more electronic devices 105 may communicate with the one or more servers 115 via the communications network 110 to request access to the application environment, provide coding information for the application environment, provide data from participants and/or the like.

The communications network 110 may serve as an information highway interconnecting the other illustrated components. The communications network 110 is not limited by this disclosure, and may include any communications network now known or later developed. The communications network 110 may utilize any suitable data communication, telecommunication, wired, wireless or other technology. The communications network 110 may be used to connect any number of devices, systems or components, and may further use any number of communications links. For example, the communications network 110 may use one or more of a local area network (LAN), a wide area network (WAN), a wireless local area network (WLAN), the internet, a cellular network, a paging network, a private branch exchange (PBX) and/or the like.

The one or more servers 115 may be coupled to the communications network 110 via a communications link, such as, for example, a wired link, a wireless link or any combination thereof. Furthermore, each electronic device 105 may be coupled to the communications network 110 via a communications link, such as, for example, a wired link, a wireless link or any combination thereof.

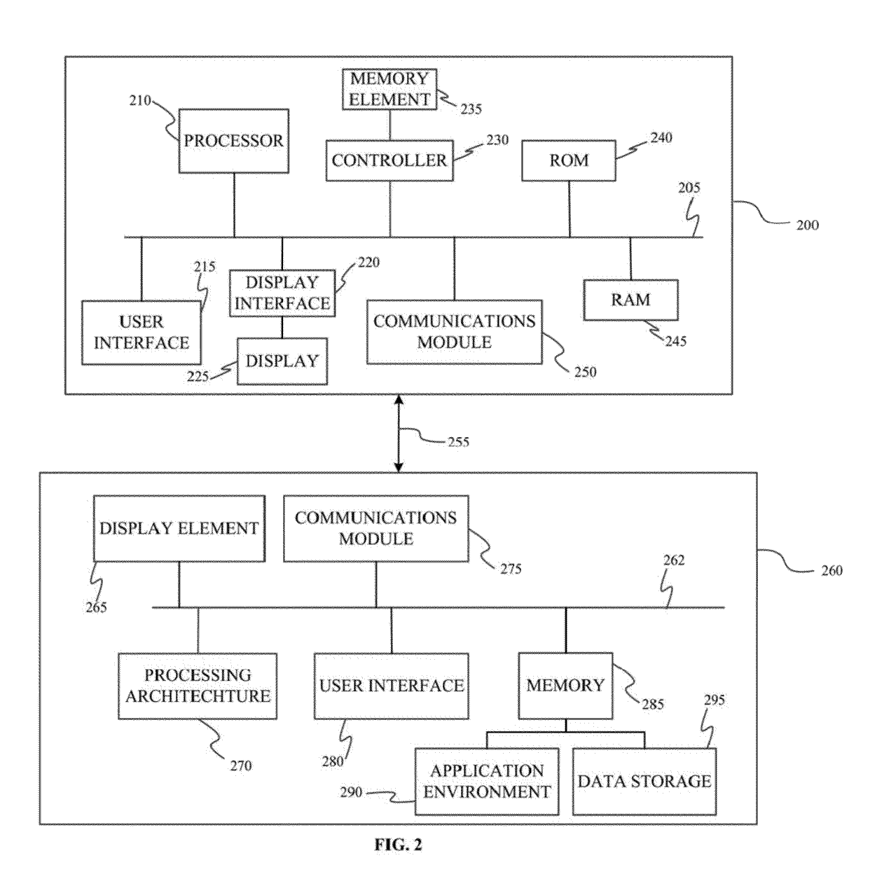

FIG. 2 depicts a schematic representation of communications between an electronic device 200 and one or more servers 260, arranged in accordance with at least some embodiments described herein. The electronic device 200 may communicate with the one or more servers 260 via a communications link 255, such as the communications network depicted in FIG. 1.

The electronic device 200 may generally include one or more of a processor 210, a user interface 215, a display interface 220, a display 225, a controller 230, a memory element 235, ROM 240, RAM 245 and a communications module 250. The modules and/or elements outlined herein are merely examples, and other modules and/or elements may also be included within the electronic device 200 without departing from the scope of the present disclosure. Examples of other modules and/or elements may include, but are not limited to, near field communication (NFC) radios, cellular radios, 802.11 wireless radios and wired data communication interfaces. A bus 205 may serve as an information highway interconnecting the modules and/or elements of the electronic device 200.

The processor 210 may generally be any processor that executes one or more operations based on programming instructions stored in the memory element 235. The one or more operations may be completed by the processor 210, or the processor may direct other components to complete the operations, as described in greater detail herein.

The processor 210 may include any number of hardware, software and/or firmware components, as well as any number of logical or functional modules. The processor 210 may be, for example, a general purpose processing device, a digital signal processor, an application-specific integrated circuit, a field programmable gate array (FPGA), a programmable logic device, a logic gate, and/or combinations thereof. The processor 210 may further be a microprocessor, a controller, a microcontroller, a state machine or any combination thereof.

The user interface 215 may include, for example, one or more user interface components that may generally be configured to elicit one or more commands to the electronic device 200 when actuated. Examples of user interface components may include keyboards, mice, keypads, interactive pen displays, switches, buttons, joysticks and/or the like.

The user interface 215 may further include a touch sensitive screen. The touch sensitive screen may receive contact-based inputs from a user, such as from a user's fingers or a stylus. The touch sensitive screen may be adapted for gesture control, thus allowing for a user to tap, pinch, swipe or provide other similar gestures to elicit commands to the electronic device 200. The touch sensitive screen may further be capable of sending touch commands to the processor 210. Examples of touch sensitive screens may include, but are not limited to, resistive touchscreens, capacitive touchscreens, infrared touchscreens and/or other technologies now known or later developed. The user interface 215 may also be configured to receive commands via body gestures, voice, audio signals, device movement and/or the like, which may be completed through the use of microphones, speakers, cameras, barometers, gyroscopes and/or the like.

An optional display interface 220 may permit information from the bus 205 to be displayed on the display 225 in audio, visual, graphic or alphanumeric format. The display 225 may generally be used to display images, text, video and the like to a user of the electronic device 200. Examples of display elements may include, but are not limited to, electroluminescent displays, electronic paper displays, vacuum fluorescent displays, light emitting diode (LED) displays, cathode ray tube (CRT) displays, liquid crystal (LCD) displays, plasma display panels, digital light processing (DLP) displays, and organic light-emitting diode (OLED) displays.

The controller 230 may interface with one or more optional memory elements 235 to the bus 205. The memory element 235 may generally be any type of fixed or removable storage device. Examples of memory elements 235 may include, but are not limited to, erasable programmable read only memory (EPROM), electric erasable programmable read only memory (EEPROM), flash memory, magnetic computer storage devices, optical discs, hard disks, removable disks, USB disks and the like.

The memory element 235 may generally provide storage for data and/or information, such as program data/information, data/information saved by one or more users, programming instructions and/or the like. The data and/or the information may further be encrypted and only accessible with the use of a decryption key and/or the like. Read only memory (ROM) 240 and random access memory (RAM) 245 may also constitute illustrative memory devices (i.e., processor-readable non-transitory storage media) that may be used in conjunction with the memory element 235.

The communications module 250 may generally provide an interface between the electronic device 200 and the communications link 255. The communications module 250 may be configured to process data transmitted or received via a wired and/or a wireless interface. The wired interface may include, but is not limited to, Ethernet, Human Interface Link (HIL), Musical Instrument Digital Interface (MIDI), Multibus, RS-232 (serial port), DMX512-A, IEEE-488 General Purpose Interface Bus (GPIB), EIA/RS-422, IEEE-1284 (parallel port), UNI/O, ACCESS.bus, 1-Wire, Inter-Integrated Circuit (PC), Serial Peripheral Interface Bus (SPI), RS-485, any Small Computer System Interface (SCSI), Process Field Bus (Profibus), Universal Serial Bus (USB), FireWire (1394), Fibre Channel, Camera Link, Peripheral Component Interconnect Express (PCI Express), Thunderbolt and the like. The wireless interface may include, but is not limited to, radio frequency (RF), infrared, near field communication (NFC), Bluetooth, any IEEE 802.15 protocol, any IEEE 802.11 protocol, any IEEE 802.16 protocol, Direct Sequence Spread Spectrum (DSSS), Frequency Hopping Spread Spectrum (FPSS), cellular communication protocols, paging network protocols, magnetic induction, satellite data communication protocols, Wireless Medical Telemetry Service (WTMS), Universal Mobile Telecommunications System (UMTS), Global System for Mobile Communications (GSM), General Packet Radio Service (GPRS) and the like.

The one or more servers 260 may communicate with the electronic device 200 via the communications link 255. The one or more servers 260 may have, for example, a display element 265, a processing architecture 270, a communications module 275, a user interface 280 and a memory 285. The list of components illustrated here is merely an example, and other components of the one or more servers 260 may be included without departing from the scope of this disclosure. A bus 262 may serve as the main information highway interconnecting the other illustrated components of the one or more servers 260.

The display element 265 may generally function in a manner similar to that of the display interface 220 and the display 225 of the electronic device 200 as previously described. Furthermore, examples of the display element 265 may include, but are not limited to, electroluminescent displays, electronic paper displays, vacuum fluorescent displays, light emitting diode (LED) displays, cathode ray tube (CRT) displays, liquid crystal (LCD) displays, plasma display panels, digital light processing (DLP) displays, and organic light-emitting diode (OLED) displays.

The processing architecture 270 may generally support the operation of the one or more servers 260, including the data processing schemes described in greater detail herein. The processing architecture 270 may be embodied in any number of hardware, software and/or firmware components, and may include any number of logical or functional modules. The processing architecture 270 may be implemented or performed with a processing device, a content addressable memory, a digital signal processor, an application specific integrated circuit, a field programmable gate array, any programmable logic device, any discrete gate or transistor logic, any discrete hardware components and/or the like. The processing architecture 270 may be, for example, a microprocessor, a controller, a microcontroller, a state machine or the like. Additionally, or alternatively, the processing architecture 270 may be implemented as a combination of devices, such as, for example, a digital signal processor and a microprocessor, a plurality of microprocessors, and/or the like.

The communications module 275 of the one or more servers 260 may generally function in a manner similar to that of the communications module 250 of the electronic device 200. The communications module 275 may generally receive one or more requests to access data and applications and may transmit one or more responses to the requests.

The user interface 280 of the one or more servers 260 may generally function in a manner similar to that of the user interface 215 of the electronic device 200. The user interface 280 may be directly connected to the bus 262 of the one or more servers 260, or may be remotely connected and located at a location that is accessible to the user. Furthermore, the user interface 280 may integrated as a portion of the user interface 215 of the electronic device 200. Examples of user interface components may include keyboards, mice, keypads, interactive pen displays, switches, buttons, joysticks and/or the like.

The user interface 280 may further include a touch sensitive screen. The touch sensitive screen may receive contact based inputs from a user, such as from a user's fingers or from a specialized stylus. The touch sensitive screen may be adapted for gesture control, thus allowing for a user to tap, pinch, swipe or provide other similar gestures to elicit commands to the one or more servers 260. The touch sensitive screen may further be capable of sending touch commands to the processing architecture 270. Examples of touch sensitive screens may include, but are not limited to, resistive touchscreens, capacitive touchscreens, infrared touchscreens and/or other technologies now known or later developed. The user interface 280 may also be configured to receive commands via body gestures, voice, audio signals, device movement and/or the like, which may be completed through the use of microphones, speakers, cameras, barometers, gyroscopes and/or the like.

The memory 285 of the one or more servers 260 may be similar to the memory element 235, the ROM 240 and/or the RAM 245 of the electronic device 200. Furthermore, the memory 285 may generally function in a manner similar to that of the memory element 235, the ROM 240 and/or the RAM 245 of the electronic device 200.

The memory 285 may generally contain programming instructions for an application environment 290, as described in greater detail herein. Thus, the one or more servers 260 may access the application environment 290 in the memory 285 to complete one or more processes, as described in greater detail herein.

The memory 285 may further provide data storage 295 for the one or more servers 260. The data stored in the data storage 295 may be obtained from one or more administrators, users, participants and/or the like.

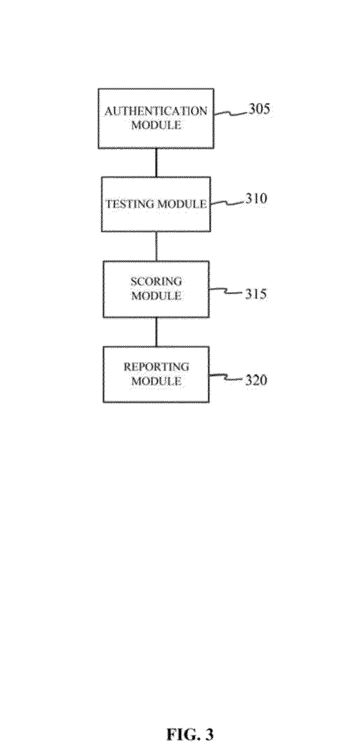

FIG. 3 depicts a diagram of the various modules completed by an application environment, according to an embodiment. The application environment may complete the various operations as described in greater detail herein within an authentication module 305, a testing module 310, a scoring module 315 and a reporting module 320. The authentication module 305 may generally contain operations for scheduling an assessment and authenticating a participant, as described in greater detail herein. The testing module 310 may generally contain operations for providing simulations, obtaining assessment measurements and the like to allow the participant to complete an assessment as well as an orientation to the simulated target job and/or level embedded in the simulation. The scoring module 315 may generally contain operations for automatically evaluating participants, automatically creating ratings at various rating levels, computing assessment scores and/or the like based upon measurements obtained in the testing module 310. The scoring module may include human and computer-generated evaluations of the participant's behavior and methods to combine ratings at various levels, such as key actions, overall-score, feedback statements and/or situational insights). The reporting module 320 may generally contain operations for compiling a report based upon the scoring and providing the report to individuals and/or entities. The modules described herein are merely illustrative and those skilled in the art will recognize that additional and/or alternate modules for completing one or more operations may be used without departing from the scope of the present disclosure. Furthermore, each module disclosed herein may contain one or more submodules. In certain embodiments, the submodules may be shared by a plurality of modules. In other embodiments, the modules described herein may be a submodule of another module (e.g., the reporting module may be a portion of the scoring module). In some embodiments, each module may operate concurrently with another module. In other embodiments, the modules may operate in succession to one another.

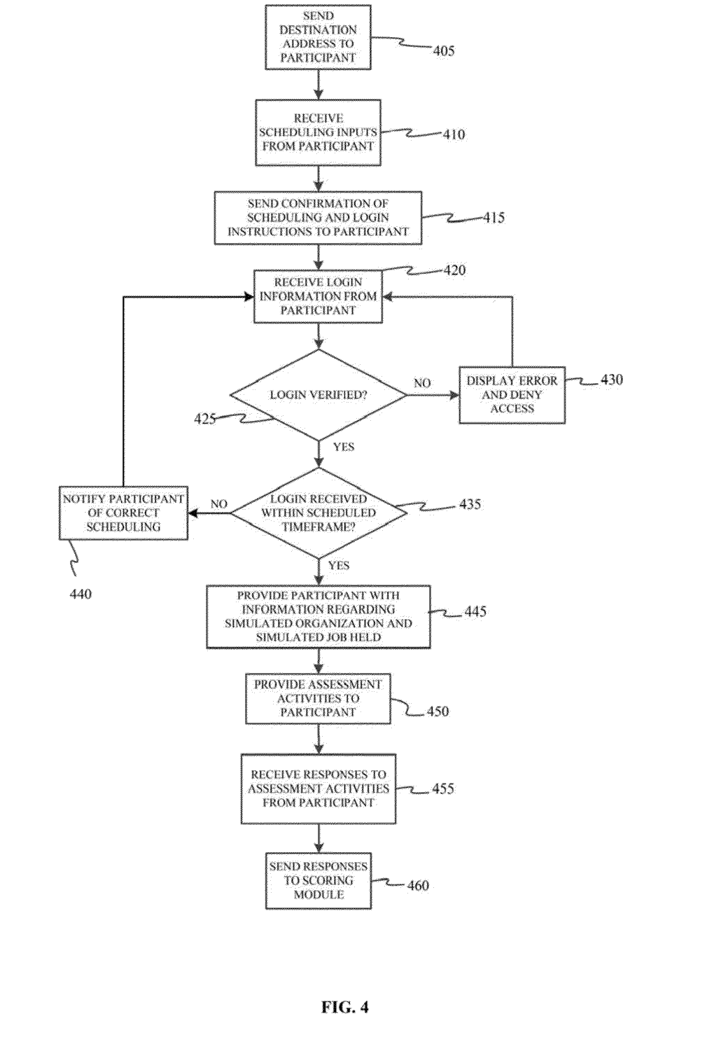

FIG. 4 depicts a flow diagram of a process for automating an assessment of a participant, according to an embodiment. The process depicted in FIG. 4 may be carried out by the application environment within the authentication module and/or the testing module. The application environment may send 405 a destination address, such as a Uniform Resource Locator (URL), a web link, a link to a server, an address and/or the like to the participant. The destination address is not limited by this disclosure, and may be a website link, an IP address, a link provided by an URL shortening and bookmarking service and/or the like that allows a participant to directly connect to the one or more servers via an electronic device. The destination address may be sent to the participant by any method of transmitting text now known or later developed, including, but not limited to email, text message, short message service (SMS), multimedia messaging service (MMS), enhanced messaging service (EMS), instant messaging, direct messaging, push messaging and other text based point-to-point communications.

As previously described, the destination address may be used to establish a direct connection between the participant's electronic device and the one or more servers containing the application environment. When accessed by the participant, the application environment may provide the participant with one or more scheduling queries to determine a time that is convenient for the participant and/or other necessary users to complete an assessment. The one or more scheduling queries may be in the form of an online form, a calendar, a series of questions and answers and/or the like. Once the application environment receives 410 scheduling inputs in response to the queries from the participant, the application environment may automatically send 415 a confirmation of the scheduling information to the participant and/or other necessary users.

The application environment may receive 420 login information from the participant at any time after sending 415 the confirmation of scheduling and the login instructions. The received login information may involve, for example, a user name and/or a password, an email address, a telephone number and any other information that may personally identify the participant to the application environment. Upon receiving 420 login information, the application environment may verify 425 that that the login information is correct. Verification may be completed by any method of authentication, such as password authentication, password-authenticated key agreement and/or security authentication now known or later developed, and may further involve the use of any number of security tokens, keys and/or the like. Verification may be received via a secure remote website, a telephone call, an electronic transmission and/or the like. If the authentication fails, such as due to the submission of incorrect login information, password and/or the like, the application environment may display 430 an error message and deny access to the system. The application environment may then receive 420 additional login information from the participant or may block the participant from obtaining access to the system, such as after the participant attempts a number of unsuccessful login authorization requests.

Once the login information has been verified, the application environment may verify 435 that the login information was received within the scheduled timeframe as provided in the confirmation previously sent. The scheduled timeframe may be the exact period of time provided in the confirmation or it may be within an acceptable period of time before or after the period of time provided in the confirmation. Examples of an acceptable period of time may include, for example, 5 minutes, 10 minutes, 15 minutes, 20 minutes, 30 minutes, 45 minutes, 60 minutes, 90 minutes, 2 hours, 5 hours, 8 hours, 12 hours, 24 hours, 36 hours and 48 hours. If the login is received at a time that is not within the acceptable period of time, the application environment may notify 440 the participant of the scheduled time and may further instruct the participant to attempt a login at a time within the acceptable period of time.

If the login is received within the acceptable period of time, the application environment may provide 445 the participant with information regarding situations and tasks related to a target job and/or job level. The target job and/or job level may be geared toward a specific position, such as, for example, a frontline manager, a sales associate, a professional associate, an executive or the like. The job may be a simulated job that parallels the actual target job and/or job level so that the assessment can be used to determine how the participant would act in certain important and representative situations and tasks associated with the target job and/or job level. Alternatively, the job may be an actual job. Whether actual or simulated, the assessment may be used to determine how a potential employee would act in situations expected in the actual job or how a current employee would act if promoted or otherwise given a different job. The application environment may further instruct that participant to take on a target role, such as, for example, an employee, a manager, an executive and/or the like in an organization. The application environment may further provide background information about the position the applicant is to take on, as well as information regarding one or more of the following: the organization, the organization's organizational arrangement, the organization's mission statement, the organization's policies, the participant's supervisor, the organization's key stakeholders, the participant's direct reports, the organization's customers, the organization's competitors, a competitor's products and/or the like.

After providing 445 the participant with job information, the application environment may provide 450 assessment activities and/or tasks to the participant. The assessment activities and/or tasks may include a detailed interface that simulates common tasks and the like that are to be performed by the participant and/or others in target positions within an organization, which may further occur across a wide variety of countries, industries, customs and/or the like. The assessment activities may generally be designed to elicit responses from the participant that allow for evaluation of key actions, as described in greater detail herein. Examples of assessment activities that parallel tasks in the target job and/or job level may include, for example, presenting business issues requiring responses to preset options, yes/no answers, detailed answers in written form, graphic form, verbal form and/or the like. Other assessment activities may also include providing scenarios and the like to assess how the participant responds to such scenarios, providing a videogame-like interface, providing an interactive interface, providing video clips, providing audio clips, providing emails, providing letters, providing internet text chat, providing internet video chat and/or the like.

The application environment may simulate conditions that require the participant to develop plans, complete schedules, investigate problems related to efficiencies, investigate problems related to growth, investigate problems related to service, analyze budget reports, analyze financial reports, develop budget reports, develop financial reports, plan strategies for influencing and coaching others, manage conflict and/or other similar activities not specifically enumerated herein. The application environment may further simulate conditions that require the participant to communicate with internal stakeholders, customers, direct reports and/or the like through the use of various communication methods, such as, for example, written communication, audio communication, video communication, in-person communication, presentations and/or the like within the simulation. All of the simulations provided by the application environment may be presented to the participant with the goal of simulating real world challenges of a position without requiring the costs associated with traditional assessment methods. Simulations may vary in length and/or duration. For example, in an embodiment, a simulation may take about 1 minute for a participant to complete. In another embodiment, a simulation may take about 10 minutes for a participant to complete. In another embodiment, a simulation may take about 15 minutes for a participant to complete. In another embodiment, a simulation may take about 30 minutes for a participant to complete. The amount of time necessary for a participant to complete each simulation in the automated assessment disclosed herein may generally be less than the amount of time necessary to complete simulations in other assessments known in the art. Each simulation may be configured to contain one or more discrete observation points. Examples of observation points may include, for example, assessing how a participant responds to a direct report's concerns, states expectations, summarizes arguments, makes a case for behavioral change, reviews data related to business issues, draws conclusions about underlying problems, generates alternatives and evaluates situations to arrive at a decision. Each observation point, either alone or in combination with others, may provide the application environment with information for evaluating and/or rating the participant's behavior.

As the simulation occurs, the application environment may continuously receive 455 responses to the assessment activities from the participant and may further send 460 the responses to the scoring module for scoring. Responses may be received 455 in the form of menu selections, text entries, completion of activities, voice actions, mouse clicks and/or the like, as described in greater detail herein. Certain responses may be behavioral, where the response elicits a certain behavior that the assessment may be designed to discover. The application environment may request that the responses be presented in a manner similar to how the participant would respond if the assessment was a real-life presentation of job issues, activities and the like. In some embodiments, responses may be sent 460 to the scoring module continuously as they are received 455. In other embodiments, the application environment may wait until all responses are received 455 before sending 460 the responses to the scoring module.

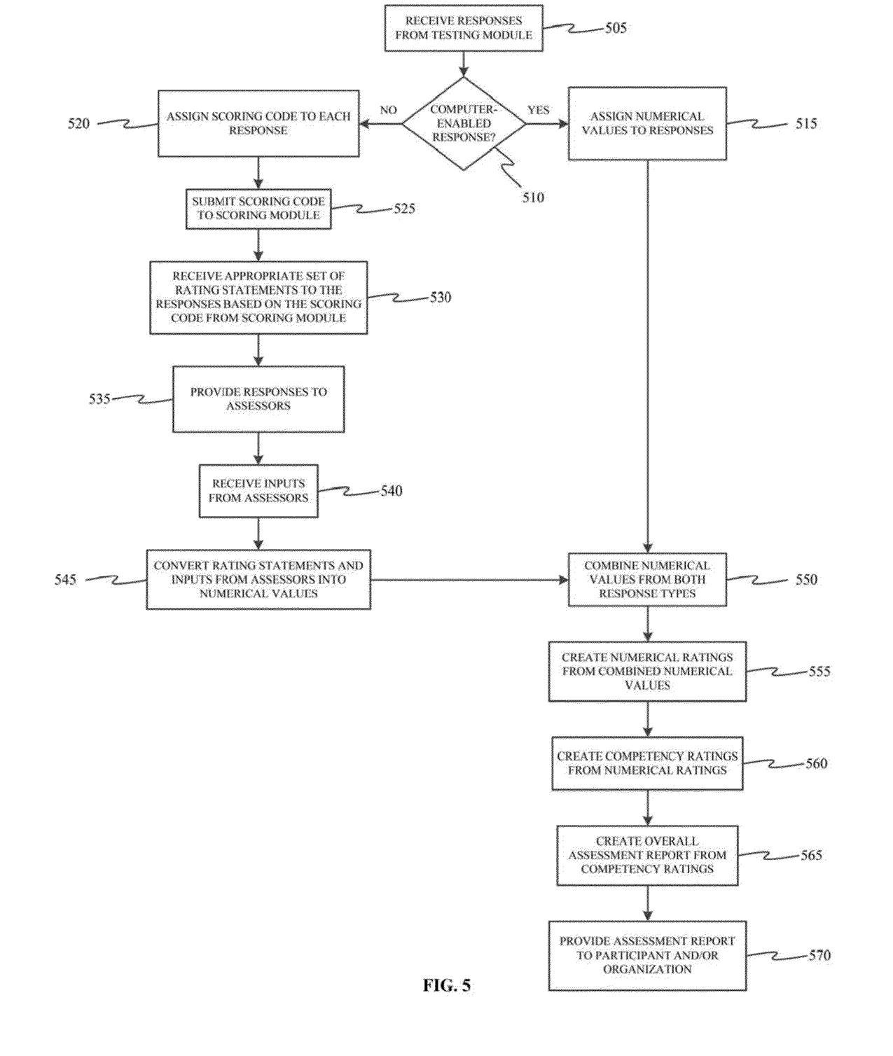

FIG. 5 depicts a flow diagram of a process for scoring of an assessment of a participant, according to an embodiment. The process depicted in FIG. 5 may be carried out by the scoring module and/or the reporting module, as described in greater detail herein. The application environment may receive 505 the responses to the assessment activities from the participant and may determine 510 whether the responses received are computer-enabled. Responses may generally be computer-enabled if they contained prepopulated, pre-determined and/or “canned” responses, i.e., the responses were contained within a menu item selected by the participant, were yes/no responses, computer interactions, dragging and dropping actions, written actions, audio and video responses, using gesture-based inputs and/or the like.

If the responses are computer-enabled, the application environment may assign 515 a first set of one or more numerical values to each response or a group of responses. The one or more numerical values selected for each response or group of responses may be pre-determined according to a rating system, as described in greater detail herein. The rating system may be based upon prior job analysis, validity studies and/or the like.

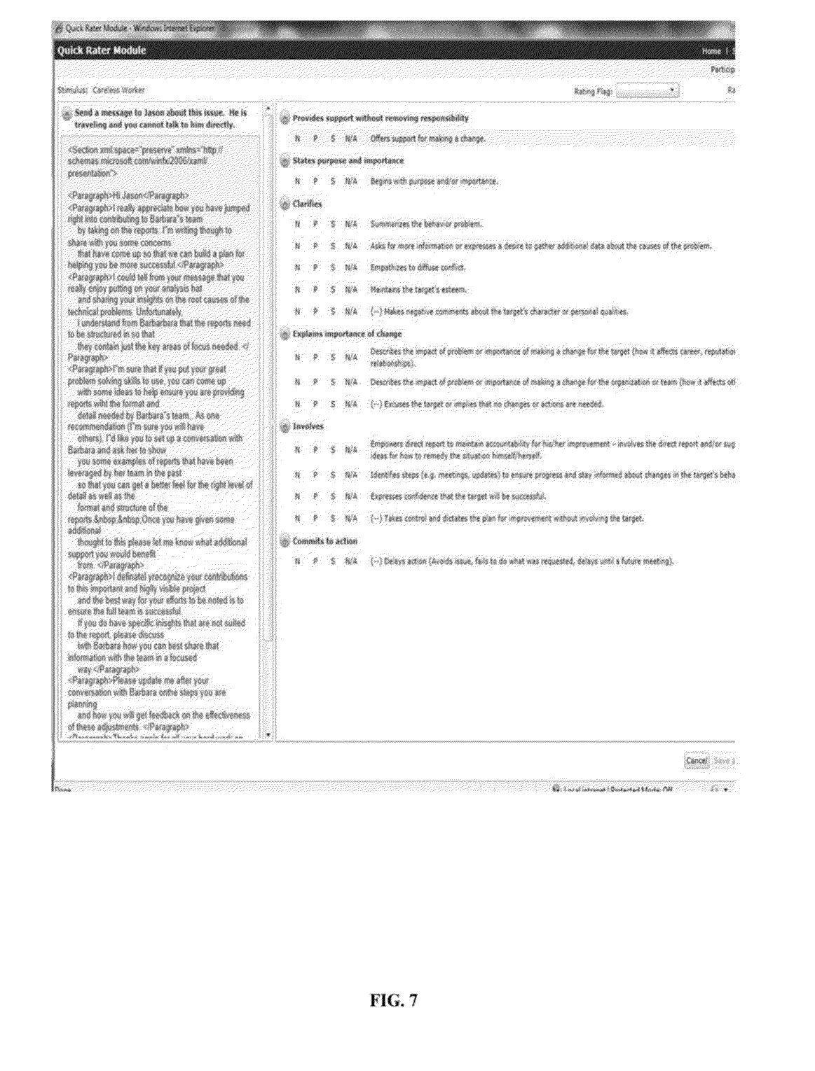

If the responses are not computer-enabled, the application environment may assign 520 a scoring code to each response that corresponds to specific assessment stimuli. The scoring code may include, for example, information regarding the participant, one or more key action designations and a pre-defined contextual or situation. The application environment may send 525 each scoring code to the scoring module and receive 530 a plurality of possible ratings from the scoring module for each scoring code. The plurality of possible ratings or selections may be a plurality of statements, menu entries and/or the like. The application environment may provide 535 these participant responses to one or more assessors for evaluation, wherein the one or more assessors are tasked with rating a response, as shown in FIG. 7. For example, an assessor may be required to select the responses that best describe the participant's behavior. Returning to FIG. 5, the assessor selection may be associated with the most appropriate rating for behavior demonstrated by the participant. Providing the assessors with the rating guidelines and a participant's responses, the evaluation may be completed by, for example, placing and the responses in a queue and providing on a first-in-first-out basis, providing according to a predetermined prioritization scheme, providing according to each assessor's specialization and/or the like. In an alternative embodiment, the application environment may automatically evaluate each response and automatically identify the rating that most closely resembles the response.

The assessors may be, for example, individuals employed by the entity providing the automated assessment, independent contractors, assessment software and/or the like. In embodiments where the assessors are individual persons, they may generally be extensively trained to observe the actions of the participant and make evaluations related to the target job and/or job level. In embodiments where the assessors are replaced by assessment software, the software may be configured to record data pertaining to the actions of the participant and evaluate such data. The assessors may use a highly structured evaluation process and guidelines to ensure consistency in how the same participant behaviors are evaluated across assessors.

In embodiments where the assessors are individuals, the assessors may not evaluate entire competencies; rather, the assessors may rate behaviors related to one or more key actions that correspond to one or more of the discrete tasks or situations. The assessor may not know whom they are rating or what other responses were made by a particular participant. The application environment may associate the key actions with the proper competencies. As a result, numerous rating problems common to conventional assessment centers may be avoided, such as, for example, halo effects and other forms of rater bias.

For example, assessment centers may have problems associated with human evaluation, such as, for example, unreliability (inconsistency across assessors), halo effects and/or bias. The bias may be related to a variety of factors such as, for example, participants' attractiveness, participants' race and/or an affinity between the assessor and the participant. Some conventional assessment policies have minimized these issues through extensive training, evaluation guidelines, rules and/or the like. However, these remedial measures substantially increase the cost of maintaining scoring quality necessary to eliminate the impact of the problems.

A variety of methods may be used to overcome the errors. Examples of these methods may include, but are not limited to, computer and computer-assisted evaluation as described herein, blind scoring, independent and discrete evaluation of behaviors associated with a key action, use of multiple assessors, ongoing quality checks on assessors' ratings to ensure reliability, consistency across assessors, and/or the like. The use of such methods may ensure that the assessor does not know whom they are rating and what other responses that participant has made and only has access to small amounts of information, thereby reducing or eliminating a halo effect. In addition, such methods may ensure that an assessor, when receiving a second response from the same participant, may be unable to associate it with earlier responses.

A method of keeping assessor standards and consistency high may involve re-scoring a portion of all evaluations. In some embodiments, 5% of all evaluations may be re-scored. In other embodiments, 10% of all evaluations may be re-scored. In other embodiments, 15% of all evaluations may be re-scored. In other embodiments, 20% of all evaluations may be re-scored. In other embodiments, 25% of all evaluations may be re-scored. In other embodiments, 50% of all evaluations may be re-scored. In other embodiments, 75% of all evaluations may be re-scored. In other embodiments, all evaluation may be re-scored.

To accomplish this, each batch of assessments received by an assessor for scoring may contain a portion of assessments that have previously been scored by one or more other assessors. In some embodiments, 5% of batch may have been previously scored. In other embodiments, 15% of each batch may have been previously scored. In other embodiments, 20% of each batch may have been previously scored. In other embodiments, 25% of each batch may have been previously scored. In other embodiments, 33% of each batch may have been previously scored. In other embodiments, 50% of each batch may have been previously scored. Double scored responses by different assessors may automatically be compared to each other to ensure reliability and/or rating consistency. Actions may be taken if reliability is not obtained. Examples of such actions may include, for example, additional training, re-scoring by an expert assessor and re-assignment of the assessor.

Another method of ensuring valid scoring may involve automatic verification by the application environment to ensure the accuracy of an assessor's score. If assessors fall below standard, they may be retrained or re-assigned.

Examples of competencies may include, but are not limited to, managing relationships, guiding interactions, coaching for success, coaching for improvement, influencing, delegation and empowerment, problem and/or opportunity analysis, judgment and planning and organizing. The managing relationships competency may generally be used to observe how the participant is able to meet the personal needs of individuals to build trust, encourage two-way communication and strengthen relationships. The guiding interactions competency may generally be used to observe how the participant is able to conduct interactions with others by clarifying the purpose, involving others in the development of ideas and agreeing on future steps. The coaching for success competency may generally be used to observe how the participant is able to prepare teams and individuals to excel in new challenges through proactive support, guidance and encouragement. The coaching for improvement competency may generally be used to observe how the participant is able to address performance problems by providing specific factual feedback, to encourage ownership of the solution and to establish progress measures. The influencing competency may generally be used to observe how the participant is able to achieve agreement to ideas or plans through effective involvement and influence strategies. The delegation and empowerment competency may generally be used to observe how the participant is able to achieve results and/or build capability by assigning task and decision-making responsibilities to individuals or teams with clear boundaries, support and follow-up. The problem and/or opportunity analysis competency may generally be used to observe how the participant is able to identify problems or issues and then draw conclusions by gathering, analyzing and interpreting quantitative and qualitative information. The judgment competency may generally be used to observe how the participant is able to choose the best course of action by establishing decision criteria, generating alternatives, evaluating alternatives and making timely decisions. The planning and organizing competency may generally be used to observe how the participant is able to help individuals or teams complete work efficiently and on time by setting priorities, establishing timelines and leveraging resources. A Competency Library may include a list of competencies, and an example of the Competency Library is provided in Example 4 herein. However, the Competency Library list presented herein is not exhaustive. Other competencies now known, later developed or later discovered may be incorporated into the competency library.

As previously described herein, each competency may include three or more key actions. In certain embodiments, a competency may include 3 key actions. In other embodiments, a competency may include 4 key actions. In other embodiments, a competency may include 5 key actions. In other embodiments, a competency may include 6 key actions. In other embodiments, a competency may include 7 key actions. In other embodiments, a competency may include 8 key actions. The key actions are behaviors that research and job analysis has found critical for effective use of a competency in a target job and/or job level. Each simulation presented to the participant may be targeted to assist the assessors in evaluating behaviors related to one or more key actions. Examples of the key actions include, but are not limited to, maintain self-esteem, show empathy, provide support without removing responsibility, state the purpose and importance of meetings, clarify issues, develop and/or build others' ideas, check for understanding, summarize and/or the like. Key actions for each competency may be shared with key actions from other competencies. For example, three different competencies may share one or more of the same key actions.

Upon review and evaluation of behavior by one or more assessors, the application environment may receive 540 inputs from the assessors. The inputs received 540 from the assessors may include a rating, a numerical score, selection of phrases and/or the like. The inputs may correspond to each assessor's application of evaluation guidelines, which results in a score deserved for each response, a computed score deserved for each response, a score that has been verified by other assessors, a score that has been verified by the assessment software and/or the like. Each assessor's input may be based upon evaluation guidelines, as described in greater detail herein, to ensure that the assessor is consistently using the same scoring criteria. Based upon pre-established relevant rating guidelines, the assessors may make one or more inputs that can include numerical scores, ratings or the selection of phases and/or the like. The guidelines are described in greater detail herein.

The application environment may convert 545 the rating statements and the inputs from the assessors and/or the assessment software into a second set of numerical values that can be used by the application environment to calculate a score. The second set of numerical values may be similar to the first set of numerical values assigned 515 above. The application environment may combine 550 the first set with the second set to create key action ratings 555 as described in greater detail herein. With the combined numerical ratings from the first set and second set of numerical values (key action ratings), the application environment may create 560 one or more competency ratings for each portion of the assessment as described in greater detail herein. Based upon pre-established rules, the application environment may generate situational insights as described herein.

Once all of the competency ratings have been created 560, the application environment may create 565 an overall assessment report from the competency ratings and provide 570 the assessment report to any necessary users, such as, for example, the participant, assessors, managers/employer and/or an entity requesting access to the assessment results, an entity sponsoring the assessment, an entity providing the assessment, an entity designated by the participant, an entity designated by the entity sponsoring the assessment, an entity designated by the entity providing the assessment, a government agency, a military agency, a corporation, a nonprofit organization and/or the like. In some embodiments the application environment may provide 570 the assessment report within the scoring module and/or the reporting module.

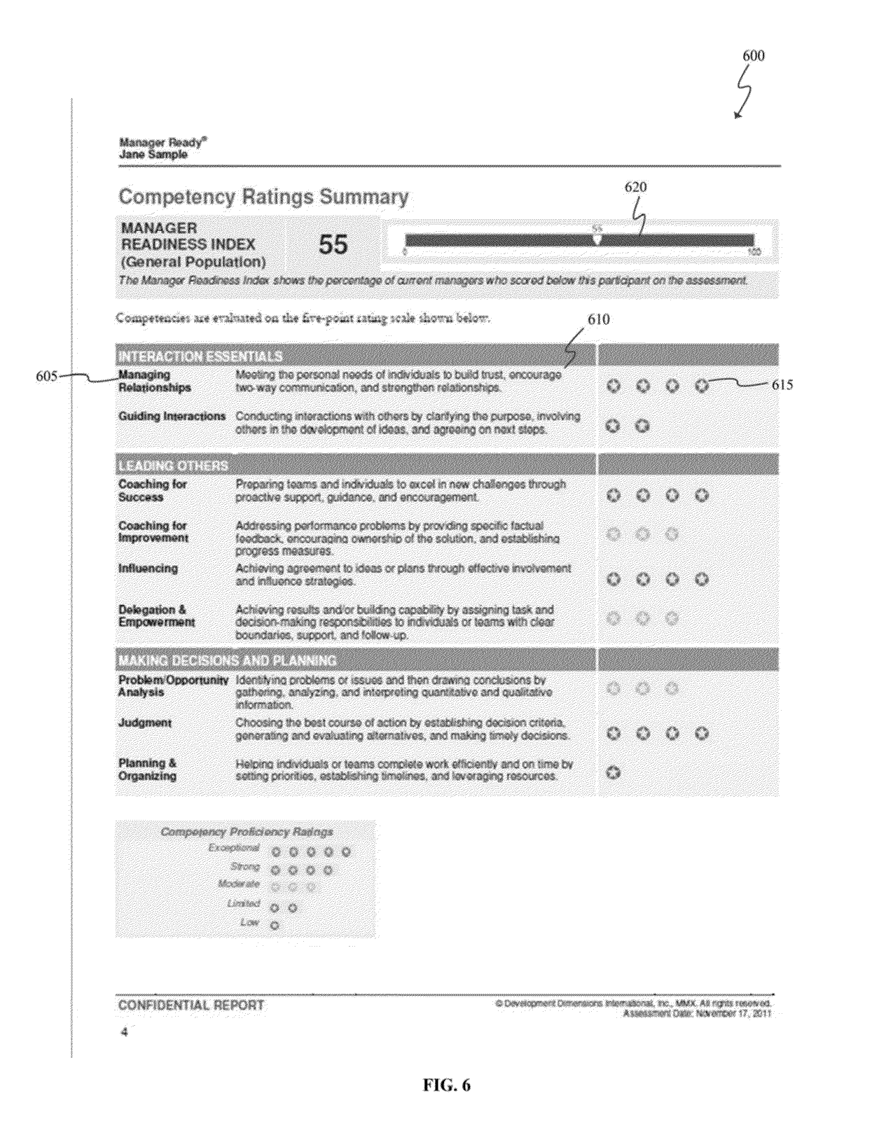

The assessment report may generally provide the participant and/or other entities with situational and contextual insights into the participant's strengths and development needs. For example, some participants may be effective when they communicate upward (e.g. to a supervisor), but not when they communicate downward (e.g. to a direct report). Other participants may make better decisions when dealing with facts and figures than when they are making decisions involving people. The report may further contain competency ratings, key action ratings, a description of behaviors that are strengths, behaviors that need to be improved and/or enhanced, behaviors that should be avoided and/or the like. An example of the summary page of the assessment report is depicted in FIG. 6. The summary page 600 may generally contain a list of one or more competencies 605 that were evaluated, as well as a description 610 for each competency. In addition, a rating 615 for each competency may be shown. In the present example, the rating is based on a star system from 1 to 5, where 1 star is the lowest rating and 5 stars is the highest rating. However, the rating is merely an example, and other ratings systems may be used in the summary without departing from the scope of this disclosure. For example, the rating may be a percentage, a number, a detailed description and/or the like. An overall rating 620 may further be shown that combines the individual competency ratings 615 together. The overall rating may be a number, a percentage, a star rating, a detailed description and/or the like. In the present example, the overall rating 620 is a “Manager Readiness Index” that is a weighted aggregate of the competency ratings 615 comparing the participant to other individuals who have completed the same assessment. Thus, the rating of 55 means that the participant in this example outperformed 55 percent of all of the other participants.

The assessment report may further provide information and/or tools to the user. The information and/or the tools may be used to assist the user in interpreting each assessment report. Examples of information and/or tools may include, for example, charts, graphs, keys, definitions, examples, explanations and/or the like.

The various embodiments may be realized in the specific examples found below.

### Example 1

### Sample Competency Assessments and their Associated Key Actions

For a competency assessment for leading change, assessors may be enabled by the software to evaluate participants' behaviors in identifying and driving organizational and cultural changes needed to adapt strategically to changing market demands, technology, and internal initiatives, catalyzing new approaches to improve results by transforming organizational culture, systems, or products/services. During this evaluation process, the assessors may be looking for specific key actions undertaken by the participant, such as:
Identifies change opportunities: Proactively recognizes the need for innovation or improvement and initiates efforts to explore alternative solutions.
Stretches boundaries: Encourages others to question established processes and traditional assumptions; seeks and uses input from diverse sources to generate alternative approaches; promotes experimentation by rewarding early adopters and their progress.
Catalyzes change: Takes action to improve organizational culture, processes, or products/services; establishes and encourages others to achieve a best practice approach; translates new ideas into concrete action plans.
Removes barriers and resistance: Strives to understand and break down cultural barriers to change; explains the benefits of change; demonstrates sensitivity to fears about change; helps individuals overcome resistance to change.
Manages relationships: Maintains open communication and builds trust and involvement through listening and responding with empathy, sharing thoughts, feelings and rationale, leveraging others' skills and asking for their ideas and options.

For a competency assessment for coaching, assessors may be tasked with evaluating participants' behaviors in providing timely guidance and feedback to help others strengthen specific knowledge and skill areas needed to accomplish a task or solve a problem. During this evaluation, the assessors may be looking for specific key actions undertaken by the participant, such as:
Clarifies the current situation: Clarifies expected behaviors, knowledge, and level of proficiency by seeking and giving information and checking for understanding.
Explains and demonstrates: Provides instruction, positive models, and opportunities for observation in order to help others develop skills; encourages questions to ensure understanding.
Provides feedback and reinforcement: Gives timely, appropriate feedback on performance; reinforces efforts and progress.

For a competency assessment for building strategic work relationships, assessors may be tasked with observing participants' behaviors in developing and using collaborative relationships to facilitate the accomplishment of work goals. During this observation, the assessors may be looking for specific key actions undertaken by the participant, such as:
Seeks opportunities: Proactively tries to build effective working relationships with other people.
Clarifies the current situation: Probes for and provides information to promote clarity.
Develops others' and own ideas: Seeks and expands on original ideas, enhances others' ideas, and contributes own ideas about the issues at hand.
Subordinates personal goals: Places higher priority on team or organization goals than on own goals.
Facilitates agreement: Gains agreement from partners to support ideas or take partnership-oriented action; uses sound rationale to explain value of actions.
Enhances self-esteem: Shows others they are valued by acknowledging their contributions, successes, and skills.

### Example 2

### Construction of Assessment Platform

A specific assessment center platform may focus on a target job and/or job level, such as, for example, a front line leader, a sales associate, executive and a manufacturing associate. The competencies and key actions may be established through a job analysis that includes interviewing and surveying job content experts in the target job across a variety of industries and cultures. The job analysis may be used to identify important and representative job activities that are then simulated in the assessment center. Once the assessment platform is configured to target job requirements, a sample of incumbents may complete the assessment process and their performance in it is evaluated. Supervisors of the study participants may be asked to provide confidential ratings of study participants' performance in the target competencies as well as rate their performance in important outcomes such as productivity, engagement, and retention. A statistical analysis may be completed to establish the relationship between the job performance and assessment center performance. The results may be used to weight and combine key action, competency, and overall ratings. The results of the job analysis and validation study may also be used to shape the evaluation prompts, guidelines given to the assessors, as well as feedback reports.

### Example 3

### Method of Scoring

Assessment results are based on a combination of assessor scored exercises (open-ended) and computer scored exercises (closed-ended). Table 1 shows an example of how both types of exercises are combined to produce an overall competency score.

TABLE 1
Assessor and Closed-Ended Scores

| | Exercise Type | | | | | |
|---|---|---|---|---|---|---|
| | | | | | Exercise 3 - Assessor | |
| | Exercise 1 - Assessor Scored | | | Exercise 2 - Closed | Scored | |
| Key Action | A1 | B1 | C1 | A2 | B2 | C2 |
| Measured | | | | | | |
| Closed- | NA | NA | NA | A. [symbol] = 5 | NA | NA |
| Ended Rating | | | | B. [symbol] = 0 | | |
| | | | | C. [symbol] = 0 | | |
| | | | | D. [symbol] = 6 | | |
| | | | | E. [symbol] = 0 | | |
| Open-Ended | A. [symbol] = 1 | A. [symbol] = 1 | A. [symbol] = 0 | Sum = 11 | A. [symbol] = 1 | A. [symbol] = 0 |
| Rating | B. [symbol] = 0 | B. [symbol] = 1 | B. [symbol] = 0 | | B. [symbol] = 1 | B. [symbol] = 0 |
| | C. [symbol] = 0 | C. [symbol] = 0 | C. [symbol] = 1 | | C. [symbol] = 0 | C. [symbol] = 1 |
| | D. [symbol] = 1 | | D. [symbol] = 0 | | | D. [symbol] = 0 |
| | E. [symbol] = 0 | | E. [symbol] = 0 | | | E. [symbol] = 0 |
| Converting | 4: | 4: A = 1 | 4: A = 1 | 4: 10-11 | 4: A = 1 | 4: A = 1 |
| ratings to a | A = 1 | AND | AND | 3: 8-9 | AND | AND |
| standard | AND | B = 1 | B = 1 | 2: 5-7 | B = 1 | B = 1 |
| scale | B = 1 | AND | AND | 1: <5 | AND | AND |
| | AND | C = 0 | C = 1 | | C = 0 | C = 1 |
| | (C = 1 | 3: | AND | | 3: (A = 1 | AND |
| | OR | (A = 1 | D = 0 | | OR | D = 0 |
| | D = 1) | OR | AND | | B = 1) | AND |
| | AND | B = 1) | E = 0 | | AND | E = 0 |
| | E = 0 | AND | 3: A = 1 | | C = 0 | 3: A = 1 |
| | 3: | C = 0 | AND | | 2: A = 0 | AND |
| | A = 1 | 2: A = 0 | B = 1 | | AND | B = 1 |
| | AND | AND | AND | | B = 0 | AND |
| | (C = 1 | B = 0 | D = 0 | | AND | D = 0 |
| | OR | AND | AND | | E = 0 | AND |
| | D = 1) | E = 0 | E = 0 | | 1: E = 1 | E = 0 |
| | AND | 1: E = 1 | 2: A = 0 | | | 2: A = 0 |
| | E = 0 | | OR | | | OR B = 0 |
| | 2: | | B = 0 | | | AND |
| | A = 0 | | AND | | | E = 0 |
| | 1: | | E = 0 | | | 1: E = 1 |
| | E = 1 | | 1: E = 1 | | | |
| Final Key | 3 | 4 | 2 | 4 | 4 | 2 |
| Action Score | | | | | | |

In this example, the competency being rated has three key actions: Key Action A, Key Action B and Key Action C. There are three separate exercises measuring the competencies, two are assessor scored (open-ended) and one is computer scored (closed-ended). Key Actions are measured at least twice (depending on their importance). In Table 1, all three Key Actions are measured twice (A1, A2, B1, B2, C1, and C2) and each exercise measures different Key Actions (see row 2). For example, Exercise 3 measures only Key Actions B and C.

Closed-ended exercises are scored immediately by the system. Typically the choices made available to the participant have assigned point values based on the results of validation results. In Table 2, the best choice for Exercise 2 is answer D, which has a point value of 6. The results of the participant's choices are summed to produce an overall raw score. In the example, the participant selected the best two options (A and D), thus earning a raw score of 11. This raw score is then converted to a standard 4-point scale.

For open-ended items, assessors use a list of behavioral statements to indicate if a behavior is present or absent. Note that for Exercise 1, Key Action A, the participant performed two of the possible five behaviors. The presence or absence of these behaviors is then submitted to an algorithm that determines a point value on a standard 4-point scale. In the example, the participant receives a value of 3 because he/she demonstrated both behavior A and behavior D (required for a score of 3). If he/she had also performed behavior B, he/she would have received a score of 4.

The overall process of scoring is to convert all responses to a standard 4-point scale. The last row of the table illustrates that the three exercises produced six individual Key Action ratings.
Key Action A: 3 and 4
Key Action B: 4 and 4
Key Action C: 2 and 2

The next step in the process is to combine the Key Action scores to produce an overall competency score. Depending on the competency, a Key Action might be weighted to determine the overall score. For example, a rule may exist that states that Key Action A should be weighted twice as much as Key Action B and four times as much as Key Action C. Thus, calculation of the Key Actions would be:
Key Action A: 3.5 (average of 3 and 4)
Key Action B: 4.0 (average of 4 and 4)
Key Action C: 2.0 (average of 2 and 2)

Total score=(3.5×4)+(4.0×2)+2

Total score=24

Then, using rules for banding the final distribution, the raw 24-point scale may be converted into a 5-point competency score for reporting, such as:
5=>19
4=18-19
3=14-17
2=8-13
1=<8

### Example 4

The list provided below is an example of the Competency Library. The list is not exhaustive and may include other competencies now known, later discovered or later developed.

Active Learning
Adaptability
Aligning Performance for Success
Applied Learning
Assignment Management
Authenticity
Becoming a Business Advisor
Broadening Business Value
Building a Successful Team
Building Customer Loyalty
Building Customer Relationships
Building Health Care Talent
Building Influential Partnerships
Building Organization Talent
Building Partnerships
Building Self-Insight
Building Strategic Work Relationships
Building the Sales Organization
Building the Sales Team
Building Trust
Building Trusting Relationships
Business Acumen
Business Savvy
Care Management
Coaching
Coaching and Developing Others
Coaching the Sales Team
Collaboration
Communication
Compelling Communication
Continuous Improvement
Continuous Learning
Contributing to Team Success
Courage
Creating a Service Reputation
Cultivating Clinical and Business Partnerships
Cultivating Networks
Customer Focus
Decision Making
Delegating Responsibility
Developing Others
Devising Sales Approaches and Solutions
Driving Execution
Driving for Results
Driving Sales Execution Through Engagement
Emotional Intelligence
Empowerment/Delegation
Energy
Engagement Readiness
Entrepreneurship
Establishing Strategic Direction
Executive Disposition
Expanding and Advancing Opportunities
Facilitating Change
Financial Acumen
Follow-Up
Formal Presentation
Gaining Commitment
Global Acumen
Guiding Sales Opportunities
High-Impact Communication
Impact
Influence
Information Monitoring
Initiating Action
Innovation
Inspiring Others
Leadership Disposition
Leading Change
Leading Teams
Leading Through Vision and Values
Leveraging Community and Staff Diversity
Leveraging Diversity
Making Health Care Operations Decisions
Making Sales Operations Decisions
Managing Conflict
Managing Work (includes Time Management)
Marshaling Resources
Meeting Leadership
Meeting Participation
Motivating the Sales Organization
Navigating Complexity
Navigating Politics
Negotiation
Operational Decision Making
Optimizing Diversity
Passion for Results
Patient Education/Health Promotion (Patient Care)
Patient Relations
Personal Growth Orientation
Planning and Organizing
Positive Disposition
Quality Orientation
Raising the Bar
Risk Taking
Safety Awareness
Safety Intervention
Sales Ability/Persuasiveness
Sales Disposition
Sales Negotiation
Sales Opportunity Analysis
Seizing Market Opportunities
Selecting Talent
Selling the Vision
Setting Health Care Business Strategy
Setting Sales Organization Direction
Setting Sales Unit Strategy
Steering Sales Opportunities
Strategic Decision Making
Strategy Execution
Stress Tolerance
Sustaining Customer Satisfaction
Technical/Professional Knowledge and Skills
Tenacity
Work Standards

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of providing an automated assessment to a user, the method comprising:
authenticating, by a processor, the user for the automated assessment;
providing, by the processor, a description of a job to the user;
providing, by the processor, a plurality of tasks to the user;
receiving, by the processor, a plurality of responses, wherein each response is elicited by at least one of the plurality of tasks;
associating, by the processor, one or more first numerical scores with at least one response;
providing, by the processor, at least a portion of a response to an evaluator for evaluation according to predetermined criteria;
receiving, by the processor, one or more evaluations for at least a portion of one response;
associating, by the processor, one or more second numerical scores that correspond to at least one evaluation; and
processing, by the processor, the one or more first numerical scores and the one or more second numerical scores to obtain an assessment rating.

2. The method of claim 1, further comprising providing one or more assessment reports, wherein each assessment report comprises the assessment rating to one or more of the participant, the evaluator and a business entity requesting the automated assessment.

3. The method of claim 1, further comprising:
providing one or more assessment reports, wherein each assessment report comprises the assessment rating to the user; and
providing one or more of information and tools to the user, wherein the one or more of the information and the tools are used to aid the user in interpreting each assessment report.

4. The method of claim 1, wherein the assessment rating comprises one or more of a feedback statement, a key action rating, a competency rating and an overall rating.

5. The method of claim 4, wherein each competency rating comprises three or more key actions.

6. The method of claim 5, wherein at least one key action is shared by a plurality of competency ratings.

7. The method of claim 4, wherein the one or more competency ratings are selected from a competency library.

8. The method of claim 1, wherein the processing comprises:
adding, by the processor, the one or more first numerical scores and the one or more second numerical scores to obtain a combined numerical score;
converting, by the processor, the combined numerical score to a weighted score; and
assigning, by the processor, the weighted score to a predetermined assessment rating that corresponds to the weighted score.

9. A system for providing an automated assessment to a user, the system comprising:
a processor; and
a non-transitory, processor-readable storage medium in communication with the processor, wherein the non-transitory processor-readable storage medium contains one or more programming instructions that, when executed, cause the processor to:
receive a remote login request from the user;
provide a description of a job to the user;
provide a plurality of tasks to the user;
receive a plurality of responses, wherein each response is elicited by at least one of the plurality of tasks;
associate one or more first numerical scores with at least one response;
provide at least a portion of a response to an evaluator for evaluation according to predetermined criteria;
receive one or more evaluations for at least a portion of one response;
associate one or more second numerical scores that correspond to at least one evaluation; and
process the one or more first numerical scores and the one or more second numerical scores to obtain an assessment rating.

10. The system of claim 9, further comprising one or more programming instructions that, when executed, cause the processor to provide one or more assessment reports, wherein each assessment report comprises the assessment ratings to one or more of the participant, the evaluator and a business entity requesting the automated assessment.

11. The system of claim 10, further comprising one or more programming instructions that, when executed, cause the processor to provide one or more of information and tools to the user, wherein the information and the tools are used to aid the user in interpreting each assessment report.

12. The system of claim 9, wherein the assessment rating comprises one or more of a feedback statement, a key action rating, a competency rating and an overall rating.

13. The system of claim 12, wherein information relating to each competency rating comprises three or more key actions.

14. The system of claim 13, wherein at least one key action is shared by a plurality of competency ratings.

15. The system of claim 12, wherein information relating to the one or more competency ratings are selected from a competency library.

16. The system of claim 9, wherein the one or more programming instructions that, when executed, cause the processor to process the one or more first numerical scores and the one or more second numerical scores to obtain an assessment rating further comprises one or more programming instructions, that when executed, cause the processor to:
add the one or more first numerical scores and the one or more second numerical scores to obtain a combined numerical score;
convert the combined numerical score to a weighted score; and
assign the weighted score to a predetermined assessment rating that corresponds to the weighted score.

17. A method of ensuring scoring accuracy of an assessor in an automated assessment, the method comprising:
receiving, by a processor, a plurality of assessment responses from a participant;
assigning, by the processor, at least one of the assessment responses to the assessor for assessment, wherein the identity of the participant is hidden from the assessor;
receiving, by the processor, at least one rating from the assessor, wherein each rating corresponds to one or more of the assessment responses; and
verifying, by the processor, that the ratings are accurate.

18. The method of claim 17, wherein the verifying comprises:
comparing, by the processor, the ratings received from the assessor with one or more supplementary ratings of the same response received from one or more additional assessors;
if the ratings received from the assessor are substantially similar to the one or more supplementary ratings:
tagging, by the processor, the ratings as correct ratings; and
if the ratings received from the assessor are not substantially similar to the one or more supplementary ratings:
tagging, by the processor, the ratings as incorrect ratings, and
reporting, by the processor, the incorrect ratings.

19. The method of claim 17, wherein the verifying comprises:
comparing, by the processor, the ratings received from the assessor with one or more supplementary ratings received from a server;
if the ratings received from the assessor are substantially similar to the one or more supplementary ratings:
tagging, by the processor, the ratings as correct ratings; and
if the ratings received from the assessor are not substantially similar to the one or more supplementary ratings:
tagging, by the processor, the ratings as incorrect ratings, and
reporting, by the processor, the incorrect ratings.
